(19) United States
(12) Patent Application Publication
(10) Pub. No.: US 2002/0139108 A1
(43) Pub. Date: Oct. 3, 2002

(54) Exhaust thrust booster for a thrust generator

(76) Inventor: Daniel L. Hilden, Forest Lake, MN (US)

Correspondence Address: VIDAS, ARRETT & STEINKRAUS, Suite 2000, 6109 Blue Circle Drive, Minnetonka, MN, 55343-9185, US

(21) Appl. No.: 09/825,120

(22) Filed: Apr. 3, 2001

(51) Int. Cl. F02K 1/36

(52) U.S. Cl. 60/204; 60/262

(57) ABSTRACT

An exhaust thrust booster for a thrust generator comprises an elongated metallic tube having a bore extending therethrough from an entrance end to an exit end. The booster also having a plurality of air intake ports acutely angled through the tube into the bore toward the exit end of the tube. The entrance end of the tube is fixedly mounted about the exhaust end of a thrust generator with the edge of the entrance end engageably mounted to the exterior surface of the thrust generator. The thrust generator expels exhaust out the exhaust end thereof, traversing the openings to the air intake ports. This causes a drop in air pressure proximate the air intake ports, resulting in air being sucked or drawn into the bore through the air intake ports and being added to the exhaust, effecting up to twenty five percent more thrust or force as the exhaust and air are expelled out the exit end of the exhaust thrust booster.

### CROSS-REFERENCE TO RELATED APPLICATIONS

Not Applicable

### STATEMENT REGARDING FEDERALLY SPONSORED RESEARCH

Not Applicable

### BACKGROUND OF THE INVENTION

This invention relates to an exhaust thrust booster for a thrust generator, such as a jet engine, to produce up to twenty five percent more thrust without having to increase fuel and or energy consumption. There have been attempts to increase thrust without having to increase fuel consumption such as implementing venturi tubes within the booster sections of the thrust generators to increase the speed of the exhaust. One known device is a JET ENGINE THRUST ENHANCER, disclosed in U.S. Pat. No. 3,604,663. The JET ENGINE THRUST ENHANCER comprises a bell-shaped member disposed forward of the engine intake throat and modified in combination with a lift channel for increase operating efficiency. Another device is a TURBINE ENGINE THRUST BOOSTER, disclosed in U.S. Pat. No. 4,314,445. The TURBINE ENGINE THRUST BOOSTER comprises an engine in combination with a means to control engine fuel delivery to adjust engine thrust, a means to generate thrust trim signals to limit engine thrust, and a means to energize the trim signals. This invention relates to implementing a system to more efficiently control or regulate the mechanical operation of a turbine engine without introducing a new apparatus connected to the engine to produce more thrust as described in the present invention. Another known device is a BOOSTER-SUSTAINER ROCKET ENGINE AND METHOD, disclosed in U.S. Pat. No. 4,901,525. The BOOSTER-SUSTAINER ROCKET ENGINE AND METHOD comprises a bipropellant self-contained propulsion system having a plurality of turbo pump assemblies provided to take liquid propellants from low pressure storage tanks to a substantially higher pressure thrust chamber. This invention uses chemicals such as propellants in such a manner to generate and sustain thrust rather than coupling a new apparatus to the engine to generate greater thrust as does the present invention. Another known device is a safety nozzle extender removably coupled to an air jet nozzle to protect the user against injury should the end of the nozzle extender become plugged.

Another known device is GB 1438111 which shows small openings in the jet tube to allow for cooling the exhaust for noise attenuation. The openings shown in this device are to small to allow this device to function as an exhaust thrust booster. Applicant has found that the openings in the jet tube need to be at least as large as the opening through which the exhaust exits the thrust generator in order to provide greater thrust.

The nozzle extender comprises a tube having a bore extending therethrough from an entrance end to an exit end and having holes through the wall of the tube to allow compressed air to escape to prevent injury to the user. This invention also increases air flow out to the exit end of the nozzle extender but was not constructed to be mounted or coupled to a thrust generator to produce increased exhaust thrust as is the present invention. There is a need for an exhaust thrust booster for a thrust generator, which generates greater thrust without having to increase fuel consumption.

### SUMMARY OF THE INVENTION

This invention relates to an exhaust thrust booster for a thrust generator comprising an elongate metallic tube having a bore extending therethrough from an entrance end to an exit end and two air intake ports extending through the wall of the tube and into the bore. The air intake ports, or air scopes are preferable acutely angled toward the exit end of the tube. The two air intake ports are generally spaced 180 degrees about the tube and enter the bore from opposite sides thereof. The entrance end of the tube is tapered to mountably attach at the exhaust end and about the exterior surface of the thrust generator. The thrust generator can create and eject a continuous jet of exhaust out of the exhaust end of the generator and out the exit end of the exhaust thrust booster at a high velocity. This causes a substantial drop in air pressure at the two intake ports bored in the tube, which creates a substantial suction from inside the bore at the air intake ports. Substantial quantities of air is sucked into the bore through the air intake ports from outside the exhaust thrust booster and is added to the jet exhaust jetting through the bore of the exhaust thrust booster. This effects up to twenty five percent greater thrust than a generator not equipped with the exhaust thrust booster.

### BRIEF DESCRIPTION OF THE DRAWINGS

FIG. 1 is a perspective view of the exhaust thrust booster;

FIG. 2 is a side elevation view of the exhaust thrust booster attached to a thrust generator;

FIG. 3 is a side cross-sectional view of the exhaust thrust booster and said thrust generator taken from FIG. 2;

FIG. 4 is a frontal perspective view of the exhaust thrust booster securely attached to the exterior surface of a thrust generator, and

FIG. 5 is a side cross-sectional view of the diverters which are used to help direct fluid flow into the opening(s) of FIG. 1.

### DETAILED DESCRIPTION OF THE DRAWINGS

While this invention may be embodied in many different forms, there are described in detail herein a specific preferred embodiment of the invention. This description is an exemplification of the principles of the invention and is not intended to limit the invention to the particular embodiment illustrated.

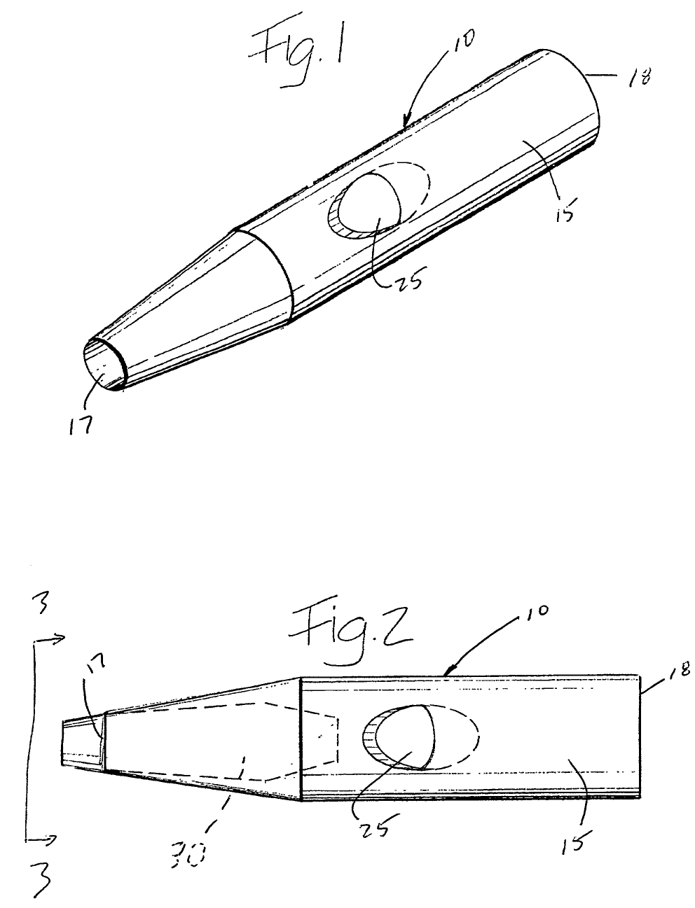

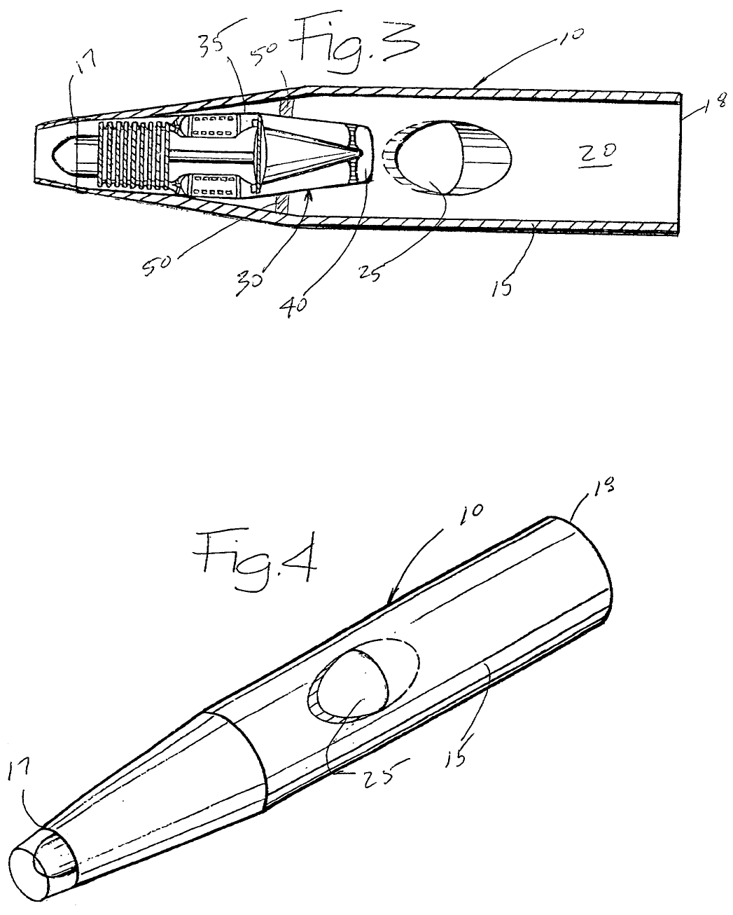

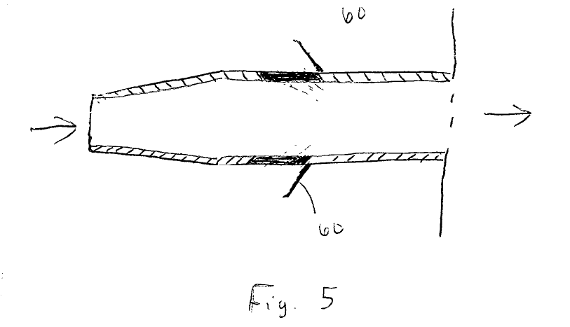

Referring to FIGS. 1 through 4 of the drawing, an exhaust thrust booster in accordance with the present invention is generally designated by the numeral 10. Exhaust thrust booster 10 comprises a lightweight, elongate metallic tube 15 having a bore 20 extending therethrough from an entrance end 17 to an exit end 18. Booster 10 also includes two or more air intake ports 25 extending through tube 15 and terminating in bore 20. Air intake ports 25 extend through tube 15 at an acute angle relative to the longitudinal axis of tube 15 and toward exit end 18 of exhaust thrust booster 10. Air intake ports 25 are generally circumferentially spaced and aligned about the tube 15. As shown in FIG. 3, tube 15 is tapered at entrance end 17 to provide a more aerodynamic surface to reduce the drag exerted on tube 15 which mountably engages the housing 35 of thrust generator 30. A plurality of brackets 50, sufficient to secure exhaust thrust booster 10 to thrust generator 30, have end portions which are riveted or otherwise fastened to housing 35 of thrust generator 30. Entrance end 17 of tube 15 generally engages housing 35 of thrust generator 30 to form a continuous surface over which air can flow with little resistance or drag. Housing 35 may also be riveted or otherwise fastened to tube 15 near entrance end 17. An exhaust end 40 of thrust generator 30 extends into the bore 20 through entrance end 17 of the tube 15. Bore 20 preferably has a diameter approximately four times greater than that of the passage through exhaust end 40 of thrust generator 30. Additionally, the air intake ports 25 each have a diameter as large as structurally feasible to allow large quantities of air through ports 25 into bore 20 from outside exhaust thrust booster 10 to effect greater thrust. In operation, exhaust generated by thrust generator 30 is jetted out though exhaust end 40 of thrust generator 30 into bore 20, and out of exit end 18 of booster 10. The exhaust generates thrust which propels generator 30 forward, opposite the direction of the exhaust. The quantity and the speed of jet exhaust escaping exhaust end 40 of thrust generator 30 determines the amount of thrust. The greater the speed and quantity of jet exhaust being jetted out thrust generator 30, the greater the thrust and force generated to propel thrust generator 30 forward. The exhaust jetted through exhaust end 40 of thrust generator 30 enters bore 20 of exhaust thrust booster 10 at a high rate of speed and traverses air intake ports 25 causing a substantial drop in air pressure proximate air intake ports 25. This creates a suction of air into bore 20 through ports 25. The air entering bore 20 through air intake ports 25 is added to the jet exhaust jetting through bore 20 from the generator 30 and adds to the exhaust to effect greater thrust. It is anticipated that exhaust thrust booster 10 can be effectively used in many applications where thrust is generated to propel an object or objects through a fluid such as air or water. Numerous characteristics and advantages of the invention covered by this document have been set forth in the foregoing description. It will be understood, however, that this disclosure is, in many respects, only illustrative. Changes may be made in details, particularly in matters of shape, size, and arrangement of parts without exceeding the scope of the new use invention. The invention's scope is, of course, defined in the language in which the appended claims are expressed.

Referring now to FIG. 5, diverters 60 are provided to aid in directing fluid flow through openings 25 when moving at high speed.

The above Examples and disclosure are intended to be illustrative and not exhaustive. These examples and description will suggest many variations and alternatives to one of ordinary skill in this art. All these alternatives and variations are intended to be included within the scope of the attached claims. Those familiar with the art may recognize other equivalents to the specific embodiments described herein which equivalents are also intended to be encompassed by the claims attached hereto.

What is claimed:

1. An exhaust thrust booster for a thrust generator comprising:
an elongate metallic tube having a bore extending therethrough from an entrance end to an exit end and having at least one fluid intake port through the tube and terminating in the bore, the tube being securely mounted to the thrust generator, the tube generally extending beyond the exhaust end of the thrust generator, so that exhaust generated by said thrust generator is directed through the tube, which causes fluid to be pulled through the at least one fluid intake port to effect an increase in thrust, the at least one fluid intake port being sized to be at least as large as the exhaust opening of the thrust generator.

2. The exhaust thrust booster of claim 1 wherein the fluid is air.

3. The exhaust thrust booster of claim 1 wherein the fluid is liquid.

4. The exhaust thrust booster of claim 1, wherein the at least one port comprises two ports which are circumferentially spaced about the tube.

5. The exhaust thrust booster of claim 1, wherein the tube is mounted to the thrust generator such that said bore cooperates with the exhaust end to receive exhaust expelled through the exhaust end.

6. An exhaust thrust booster comprising:
a thrust generator; an elongated metallic tube having a bore extending therethrough from an entrance end to an exit end and having a plurality of air intake ports through the tube and terminating in the bore, the tube integrally depending from about an exhaust end of the thrust generator and beyond the exhaust end of the thrust generator, so that exhaust generated by the thrust generator is directed through the tube to effect an increase in thrust, the plurality of air intake ports being sized to be at least as large as the exhaust opening of the thrust generator.

7. An exhaust thrust booster according to claim 6, wherein the ports are circumferentially spaced about the tube.

8. An exhaust thrust booster according to claim 6, wherein the tube is mounted over the exhaust end of the thrust generator such that the bore cooperates with the exhaust end to receive exhaust expelled through the exhaust end.

9. A method to boost the thrust generated by a thrust generator comprising the steps of:
providing an elongated tube having a bore extending therethrough from an entrance end to an exit end and having a plurality of air intake ports angled through the tube terminating in the bore; attaching the tube to said generator; generating a stream of exhaust from the thrust generator; passing the stream of exhaust through the tube across the ports; decreasing the air pressure inside the tube proximate said ports; and drawing air into the bore through the ports to join with the exhaust to effect an increase in the thrust, the plurality of air intake ports being sized to be at least as large as the exhaust opening of the thrust generator.
